(19) United States
(12) Patent Application Publication
(10) Pub. No.: US 2018/0062677 A1
(43) Pub. Date: Mar. 1, 2018

(54) STABILIZING A SINGLE LEGGED SUPPORT STRUCTURE

(71) Applicant: JAVAD GNSS, Inc., San Jose, CA (US)

(72) Inventor: Javad ASHJAEE, Saratoga, CA (US)

(21) Appl. No.: 15/284,122

(22) Filed: Oct. 3, 2016

Related U.S. Application Data
(60) Provisional application No. 62/379,628, filed on Aug. 25, 2016.

(51) Int. Cl. H04B 1/08; F16M 13/02; H04B 7/185

(52) U.S. Cl. CPC H04B 1/088; H04B 7/18517; F16M 13/02

(57) ABSTRACT

Various techniques for stabilizing a single legged support structure are provided. In one example, the support structure is used in a GNSS surveying system. The GNSS surveying system includes a monopod, a GNSS receiver attached to an end of the monopod, a stabilizing device attached to the monopod, and a support structure releasably attached to the stabilizing device. The stabilizing device is configured to stabilize the monopod and GNSS receiver to remain upright without user support.

### CROSS-REFERENCE TO RELATED APPLICATIONS

This application claims the benefit of U.S. Provisional Application No. 62/379,628, filed on Aug. 25, 2016, entitled “STABILIZING A SINGLE LEGGED SUPPORT STRUCTURE,” the entire contents of which are incorporated herein by reference.

### BACKGROUND

### Field

The present disclosure relates generally to support structures. In particular, the present disclosure relates to support structures for surveying equipment.

### Related Art

Navigation receivers that use global navigation satellite systems, such as GPS or GLONASS (hereinafter collectively referred to as “GNSS”), enable a highly accurate determination of the position of the receiver. GNSS finds particular application in the field of surveying, which requires highly accurate measurements. GNSS devices are often supported by a monopod or unipod support structure. A monopod or unipod is a single legged staff or pole used to help support the GNSS device or other precision instruments in the field.

### BRIEF DESCRIPTION OF THE DRAWINGS

FIGS. 1A-D illustrate an exemplary support system viewed from various angles.

FIGS. 2A-B illustrate various enlarged views of the exemplary support system.

FIGS. 3A-C illustrate an exemplary stabilizing device viewed from various angles.

FIGS. 4A-B illustrate an exemplary support adapter viewed from various angles.

FIGS. 5A-B illustrate an exemplary stabilizing device and support adapter from various angles.

In the following description, reference is made to the accompanying drawings which form a part thereof, and which illustrate several examples of the present disclosure. It is understood that other examples may be utilized and structural and operational changes may be made without departing from the scope of the present disclosure. The use of the same reference symbols in different drawings indicates similar or identical items.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the technology as claimed. Thus, the various embodiments are not intended to be limited to the examples described herein and shown, but are to be accorded the scope consistent with the claims.

Systems and methods for stabilizing a support structure are provided. The support structure may be a monopod, unipod, or other single legged staff or pole used to support a GNSS device or other precision instrument. Typically a monopod is supported by a technician physically holding on to the monopod or instrument attached to the monopod. However, in some cases the technician may need to step away from the monopod, or may not be able to hold the monopod in a desired position due to the terrain, or for other various reasons. In these circumstances, the technician can utilize the systems and methods described herein to stabilize the monopod or other singled legged support structure. In one example, a single legged support structure is stabilized by attaching one or more auxiliary support structures to the singled legged support structure. Each of the auxiliary support structures are equipped with an adapter that allow the auxiliary support structures to attach to a stabilizing device equipped on the single legged support structure.

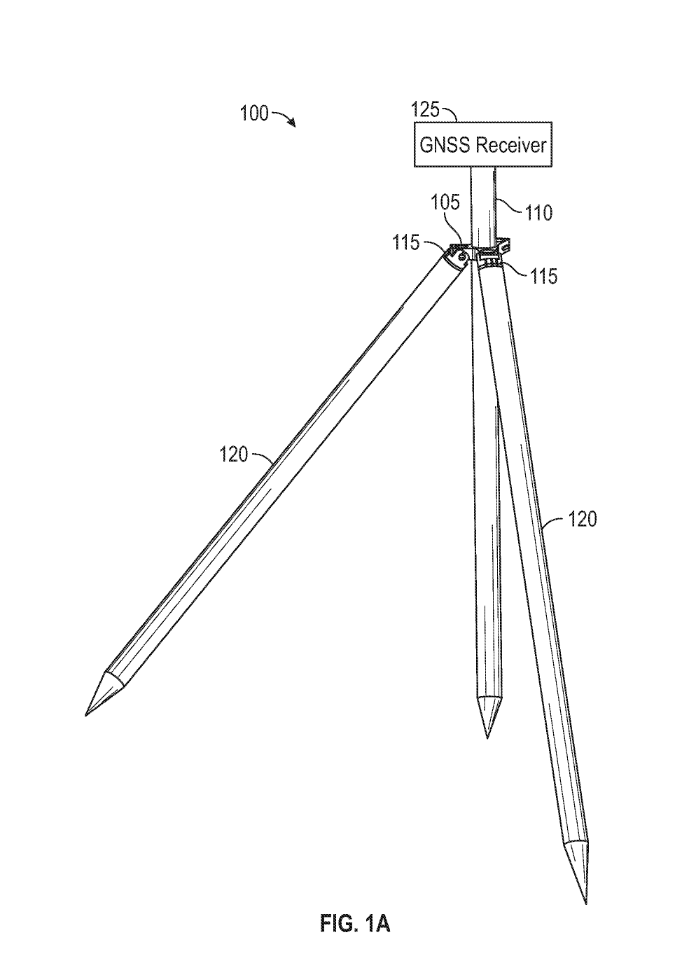

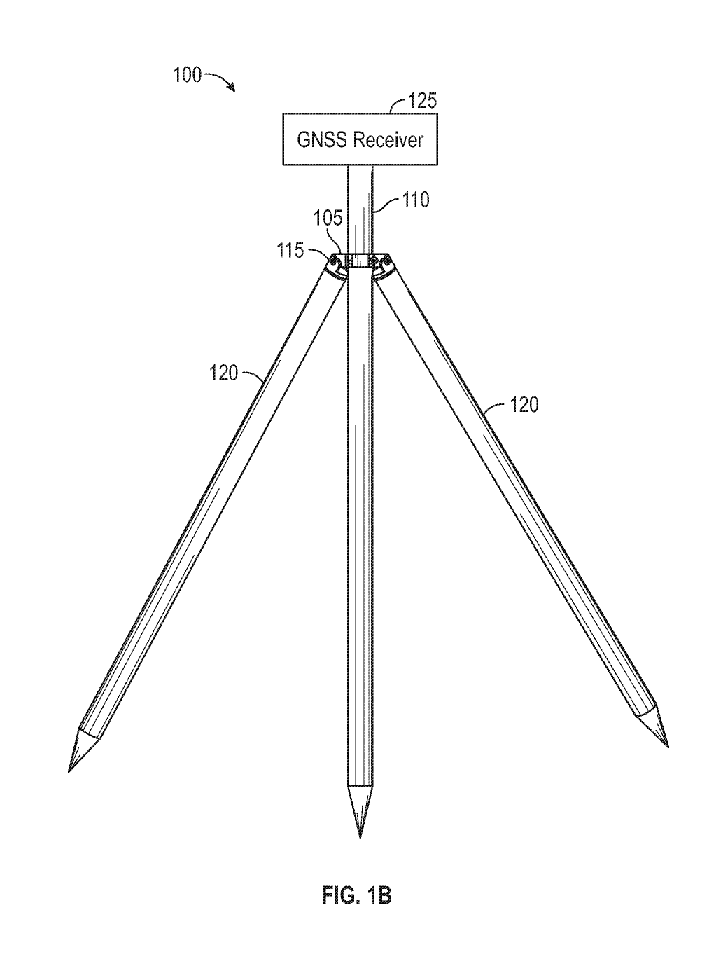

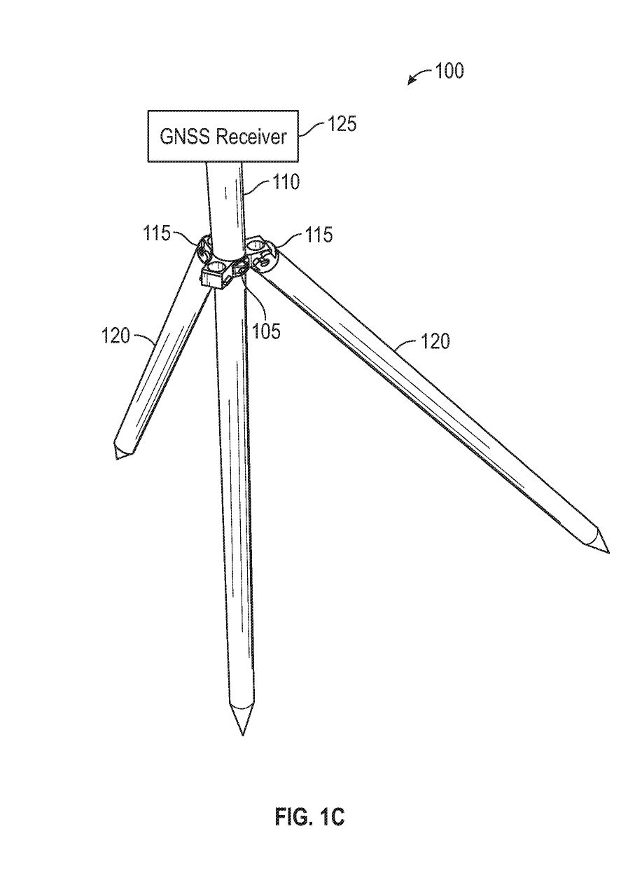

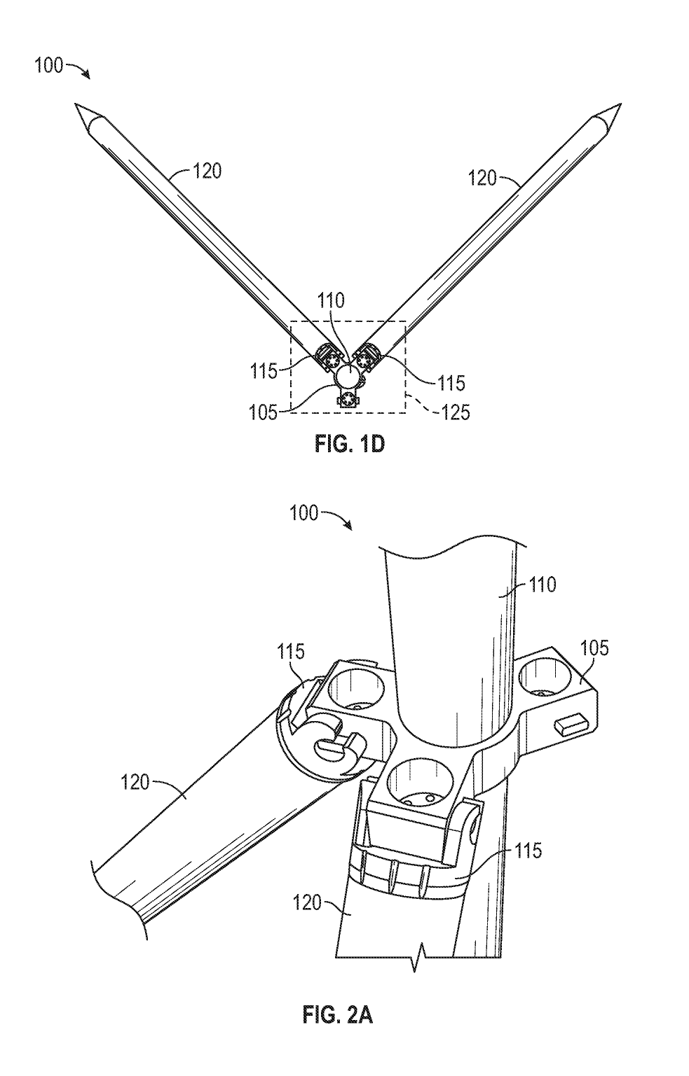

FIGS. 1A-D illustrate an exemplary support system 100 viewed from various angles. The support system 100 includes a stabilizing device 105 attached to a primary support structure 110. The primary support structure 110 may be a monopod, unipod, or other single legged staff or pole used to support an instrument. One or more auxiliary support structures 120 are connected to the stabilizing device 105 with support adapters 115. The auxiliary support structures 120 may also be monopods, unipods, or other single legged staffs or poles. The auxiliary support structures 120 stabilize the primary support structure 110 by acting as additional legs for the primary support structure 110.

The auxiliary support structures 120 may be rotated to various angles to contact the terrain so that the primary support structure 110 is stabilized in a desired position (typically in a vertical orientation). In some examples, the stabilizing device 105 includes levels and/or a compass (not shown) to aid in confirming that the primary support structure 110 is in the desired position. Stabilizing device 105 can be made out of materials, such as aluminum or other metals, that provide sufficient strength to support a monopole and any device connected to the top of it.

In one example, the support system 100 is a GNSS surveying system with a GNSS receiver 125 attached to an end of the primary support structure 110. Alternatively, the support system 100 may include other devices attached to the end of the primary support structure 110, such as a camera. In the GNSS surveying system, the stabilizing device 105 attached to the primary support structure 110 is configured to stabilize the primary support structure 110 and the GNSS receiver 125 to remain upright without user support. One or more auxiliary support structures 120 releasably attach to the stabilizing device 105 to aid in stabilizing the primary support structure 110 and the GNSS receiver 125.

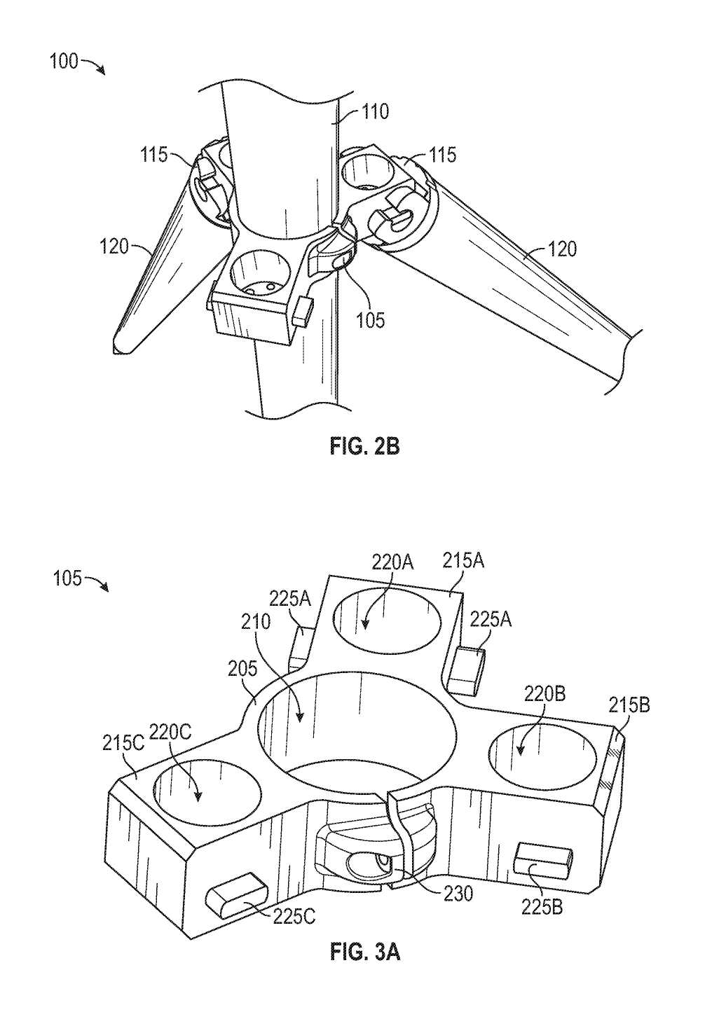

FIGS. 2A-B illustrate various enlarged views of the exemplary support system 100. As shown in FIGS. 2A-B, the support adapters 115 are installed on the tops of the auxiliary support structures 120 and rotationally engage the stabilizing device 105. A user may select which projections on the stabilizing device 105 the support adapters 115 are attached. This allows a user to select an angle between the auxiliary support structures 120 that provides better stability based on the terrain and the desired position of the primary support structure 110.

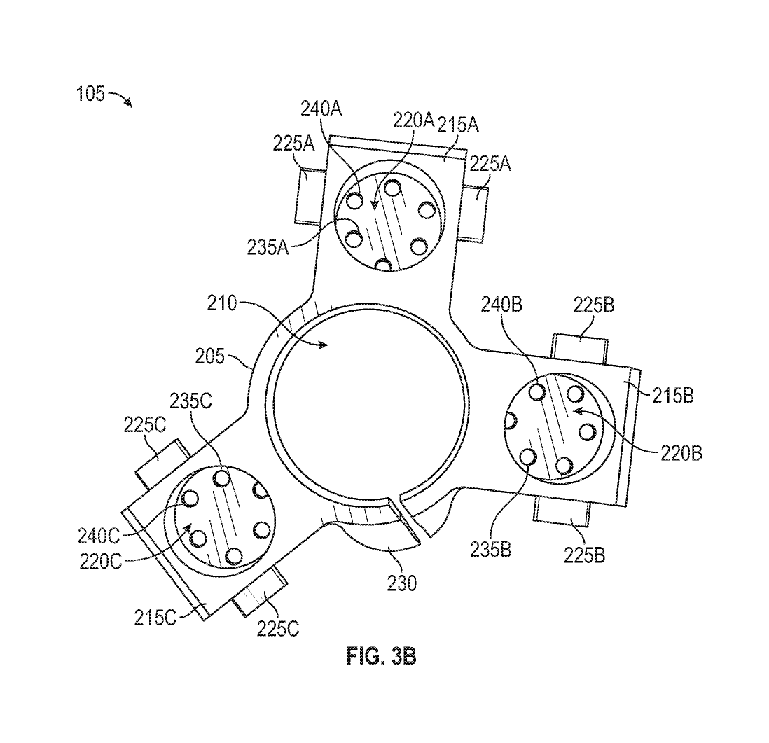

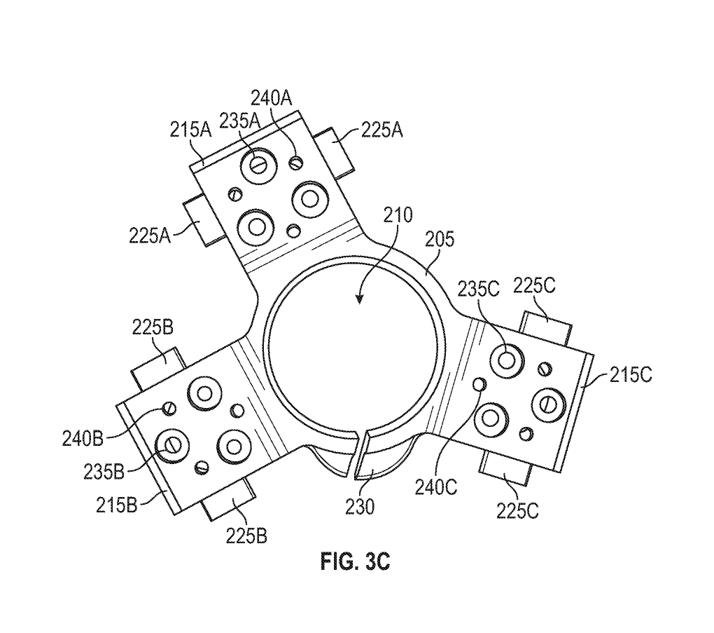

FIGS. 3A-C illustrate an exemplary stabilizing device 105 viewed from various angles. The stabilizing device 105 includes a central body 205 with a central slot 210 configured to encircle the primary support structure. The stabilizing device 105 may attach to the primary support structure using various techniques. In one example, the circumference of the central slot 210 is decreased using a tightening mechanism 230, which causes the central slot 210 to frictionally engage the primary support structure. The tightening mechanism 230 decreases the circumference of the central slot 210 with a screw (not shown) that decreases the size of the gap in the central body 205. Alternatively, the stabilizing device 105 may be attached to the primary support structure using screws, adhesive, latches, or other attachment mechanisms.

As shown in FIGS. 3A-C, three projections 215A-C extend from the central body 205 of the stabilizing device 105. In some examples, the stabilizing device 105 may include different numbers of projections, such as one, two, or four, and the angular distance between the projections may vary. For example, the angular distance between projections 215A and 215B may be less than angular distance between projections 215A and 215C or between projections 215B and 215C. The different angular distances provide different options to a user in how to bias the primary support structure 110 with the auxiliary support structures 120. For example, the projections 215A and 215B with a smaller angular distance allow the user to bias the primary support structure 110 more on one side with the auxiliary support structures 120. In one example, the angle between projections 215A and 215B is approximately 90 degrees, and the angle between projection 215C and projections 215A and 215B is approximately 135 degrees. A user may select two or more of the projections 215A-C to attach the support adapters 115 based on what angular distance between the auxiliary support structures 120 will provide better support to the primary support structure 110. Alternatively, in some examples, the angular distance between each of the projections 215A-C may be equal.

Pairs of tabs 225A-C extend from each of the projections 215A-C. Each pair of tabs 225A-C is configured to engage arms on the support adapters 115. The tabs 225A-C allow the auxiliary support structures 120 to rotate to contact the terrain at a desired angle to better stabilize the primary support structure 110. Alternatively, in some examples, the support adapters 115 may attach to the stabilizing device 105 using various other mechanisms. For example, the support adapters 115 may attach using ball and socket joints, hinges, screws, a combination of hinges and screws, or other mechanisms.

The projections 215A-C each include chambers 220A-C, respectively, configured to receive accessory devices (not shown). The accessory devices may be leveling devices, compasses, or other devices, for example, to check the orientation of the primary support structure.

As shown in the top and bottom views in FIGS. 3B-C, each of the chambers 220A-C include a bottom surface with various holes extending through the surface. Fastening holes 235A-C are configured to secure the accessory devices within their associated chambers with a fastening device, such as a screw. While each chamber 220A-C is shown with three fastening holes 235A-C, the number of fastening holes may vary. The bottom surfaces of each chamber 220A-C also include drainage holes 240A-C. The drainage holes 240A-C are configured to drain liquid from each of the chambers 220A-C. Drainage holes and fastening holes may be omitted in some stabilizing device variations.

In other embodiments, instead of accessory devices being inserted into chambers of the stabilizing device, the accessory devices are integrated into the stabilizing device. For example, the stabilizing device may include two integrated bubble levels and an integrated compass. Alternatively, the stabilizing device could also include an integrated accessory and a chamber for accepting another accessory.

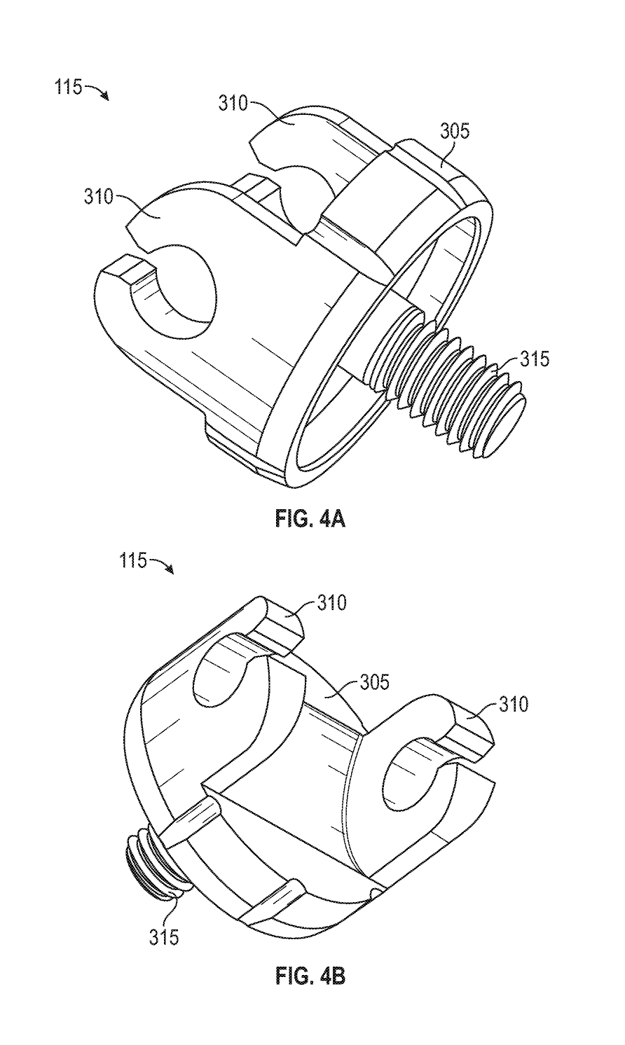

FIGS. 4A-B illustrate an exemplary support adapter 115 viewed from various angles. The support adapter 115 includes a central body 305 and arms 310 extending from the central body 305. The arms 310 are C-shaped to allow the tabs 225A-C of the stabilizing device 105 to enter the arms 310, and then rotate within the central holes in the arms 310, as further described herein. The support adapter 115 may attach to an auxiliary support structure using various techniques. For example the support adapter 115 may screw into the top of an auxiliary support structure using a threaded rod 315. Alternatively, the support adapter 115 may attach to the auxiliary support structure using adhesive, clamps, latches or other attachment mechanisms.

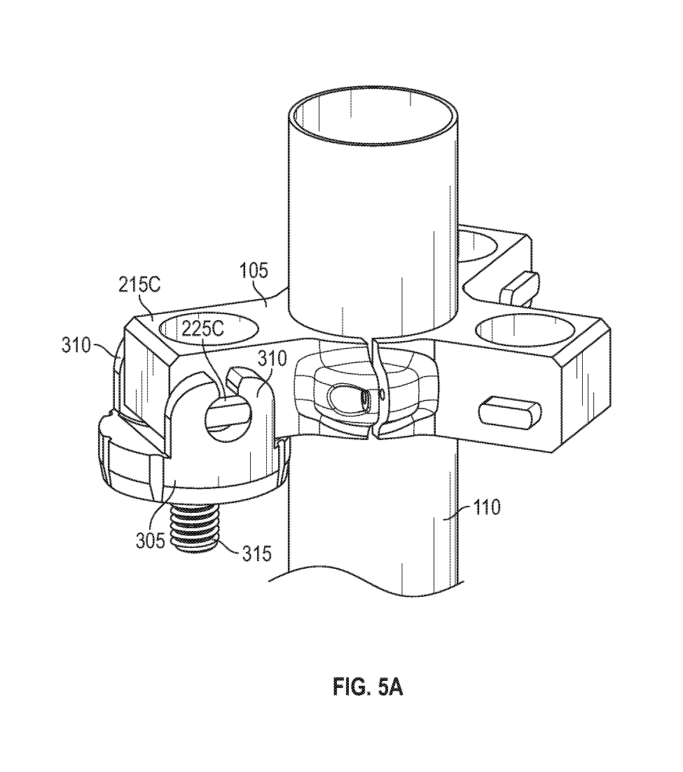

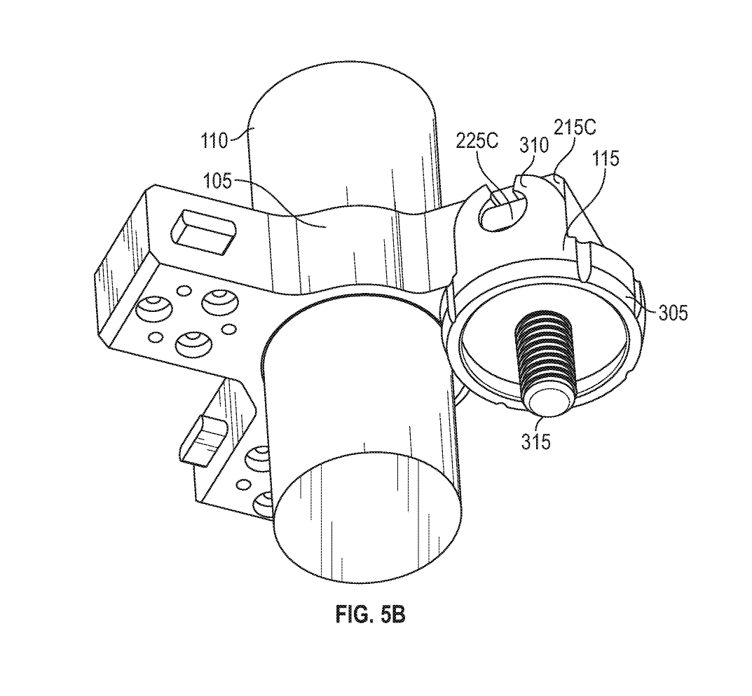

FIGS. 5A-B illustrate an exemplary stabilizing device 105 and support adapter 115 from various angles. The support adapter 115 attaches to a projection 225C of the stabilizing device 105 by engaging the pair of tabs 225C extending from the projection 225C. The C-shaped arms 310 of the support adapter 115 allow the tabs 225C to enter the central holes of the arms 310. The support adapter 115 may then be rotated to prevent the tabs 225C from exiting the C-shaped arms 310. The engagement between the arms 310 of the support adapter 115 and tabs 225C of the stabilizing device 105 allows the support adapter 115 to be positioned at various orientations relative to the stabilizing device 105. In this way, the support adapter 115 and associated auxiliary support structure (not shown) can provide stabilizing forces on the stabilizing device 105 to keep the stabilizing device 105 and the associated primary support structure 110 in a preferred position.

An exemplary method for stabilizing a primary support structure includes securing a stabilizing device to the primary support structure, securing a first support adapter to a first auxiliary support structure, and securing a second support adapter to a second auxiliary support structure. The stabilizing device may be secured to the primary support structure by decreasing the circumference of a central slot in the stabilizing device with a tightening mechanism to cause the central slot to frictionally engage the primary support structure. The primary support structure may then be stabilized by adjusting the angle of the first support adapter and the second support adapter relative to the stabilizing device. Adjusting the angle of the first support adapter and the second support adapter can include leveling the stabilizing device and/or aiming the stabilizing device in a predetermined direction.

Although a feature may appear to be described in connection with a particular embodiment, one skilled in the art would recognize that various features of the described embodiments may be combined. Moreover, aspects described in connection with an embodiment may stand alone.

1-6. (canceled)

7. A stabilization system, comprising:
a stabilizing device, wherein the stabilizing device is configured to stabilize a single legged support structure by connecting to one or more auxiliary support structures, the stabilizing device comprising:
a central body;
a central slot extending through the central body, wherein the central slot is configured to frictionally engage the single legged support structure;
a first projection extending radially from the central body comprising:
a first chamber having an opening in the top of the first projection, wherein the first chamber is configured to receive a first accessory device in the opening; and
a first pair of tabs extending from opposing sides of the first projection; and
a second projection extending radially from the central body comprising:
a second chamber having an opening in the top of the second projection, wherein the second chamber is configured to receive a second accessory device in the opening; and
a second pair of tabs extending from opposing sides of the second projection; and
at least one support adapter comprising:
an attachment mechanism configured to attach the at least one support adapter to an auxiliary support structure; and
a pair of arms configured to engage the first or second pair of tabs, wherein the at least one support adapter is configured to be rotatable into different orientations relative to the stabilizing device.

8. The system of claim 7, wherein the stabilizing device further comprises:
a third projection extending radially from the central body comprising:
a third chamber having an opening in the top of the projection, wherein the third chamber is configured to receive a third accessory device in the opening; and
a third pair of tabs extending from opposing sides of the third projection.

9. The system of claim 8, wherein an angular distance between the first and third projections is greater than an angular distance between the first and second projections.

10. The system of claim 7, wherein an angle between the first and second projections is less than 180 degrees.

11. The system of claim 7, wherein the first accessory device is a leveling device or a compass.

12. The system of claim 7, wherein the first projection further comprises a bottom surface having at least one fastening hole extending through the bottom surface into the first chamber, the at least one fastening hole configured to receive a fastening device to secure the first accessory device.

13. The system of claim 12, wherein the fastening device comprises a screw.

14. The system of claim 7, wherein the first projection further comprises a bottom surface having at least one drainage hole extending through the bottom surface into the first chamber, the at least one drainage hole configured to drain liquid from the first chamber.

15. The system of claim 7, wherein the arms of the support adapter comprise a pair of C-shaped arms configured to engage the first or second pair of tabs, wherein the tabs are rotatable within the central holes of the C-shaped arms.

16. The system of claim 7, wherein the central body further comprises:
a tightening mechanism configured to decrease the circumference of the central slot and cause the central slot to frictionally engage the single legged support structure.

17. The system of claim 16, wherein the tightening device comprises a screw.

18. The system of claim 7, wherein the at least one support adapter is configured to be manually attached and detached from the stabilizing device.

19-20. (canceled)

21. A stabilization system, comprising:
a stabilizing device, wherein the stabilizing device is configured to stabilize a single legged support structure by connecting to one or more auxiliary support structures, the stabilizing device comprising:
a central body having a central slot extending through the central body, wherein the central slot is configured to frictionally engage the single legged support structure;
a first projection extending radially from the central body having a first pair of tabs extending from opposing sides of the first projection; and
a second projection extending radially from the central body having a second pair of tabs extending from opposing sides of the second projection; and
a pair of support adapters, each support adapter being connectable to an associated auxiliary support structure, each support adapter including a pair of arms configured to engage with a pair of tabs on one of the projections, wherein each support adapter is configured to be rotatable into different orientations relative to the stabilizing device.

22. The system of claim 21, wherein the stabilizing device further comprises:
a third projection extending radially from the central body and having a third pair of tabs extending from opposing sides of the third projection.

23. The system of claim 22, wherein an angular distance between the first and third projections is greater than an angular distance between the first and second projections.

24. The system of claim 22, wherein an angle between the first and second projections is less than 180 degrees.

25. The system of claim 22, wherein an angle between the first and second projections is 90 degrees.

26. The system of claim 25 wherein the angle between the first and third projection is 136 degrees.

27. The system of claim 21 wherein each projection includes a chamber having an opening in the top surface therefore configured to receive an accessory device.

28. The system of claim 27, wherein the accessory device is a leveling device.

29. The system of claim 27, wherein the accessory device is a compass.

30. The system of claim 21, wherein the arms of each support adapter comprise a pair of C-shaped arms configured to engage a pair of tabs, wherein the tabs are rotatable within the central holes of the C-shaped arms.
